(19) United States
(12) Patent Application Publication
(10) Pub. No.: US 2025/0341831 A1
(43) Pub. Date: Nov. 6, 2025

(54) SYSTEMS AND METHODS TO ENABLE CLOUD INTERACTIONS THAT ACTUATE VEHICLE ACTIONS

(71) Applicant: FCA US LLC, Auburn Hills, MI (US)

(72) Inventors: Jonah Jacquo, Roslindale, MA (US); Lucas Romero, St. Clair Shores, MI (US); Charlie Cross, Oakland Township, MI (US); Alec Rospierski, Royal Oak, MI (US); Alan Cea, Austin, TX (US)

(21) Appl. No.: 18/652,386

(22) Filed: May 1, 2024

(51) Int. Cl. G05D 1/225; H04L 67/12; H04L 67/141

(52) U.S. Cl. CPC G05D 1/225; H04L 67/12; H04L 67/141

(57) ABSTRACT

A user connectivity system for a vehicle includes a communication system configured to communicate with cloud-based servers via a wireless communication network, the cloud-based servers hosting a set of cloud-based application programming interfaces (APIs) and a control system configured to establish a user connectivity platform that enables user customization of a plurality of sequences each for automated execution of set of respective actions by the vehicle, receive, by the user connectivity platform and from a user, user input defining a user-customized sequence defining a set of trigger conditions and a set of actions, monitor, by the user connectivity platform and using the communication system, for whether the set of trigger conditions for the user-customized sequence has been satisfied, and in response to the set of trigger conditions for the user-customized sequence being satisfied, automatically execute the set of actions for the user-customized sequence.

### FIELD

The present application generally relates to passenger vehicles and, more particularly, to systems and methods to enable cloud interactions that actuate vehicle actions.

### BACKGROUND

Conventional vehicles include features and applications that are very limited and are hardcoded by the original equipment manufacturers (OEMs), such as into a head unit infotainment system. This results in a “one-size-fits-all” functionality without any tailoring to each user. The process of developing and launching new features also takes a long time (e.g., ˜18 months) and then requires a vehicle update (e.g., a firmware over-the-air, or FOTA update). As more connected services arise, manual user monitoring of conditions (e.g., via another application, such as one executing on their mobile device) and the user then taking corresponding actions becomes increasingly difficult. For example only, the user could monitor a weather application and be alerted of an upcoming rainstorm, but the user would then be required to user another remote application or manually go to their vehicle to close the windows. Accordingly, while such conventional vehicle connectivity systems do work well for their intended purpose, there exists an opportunity for improvement in the relevant art.

### SUMMARY

According to one example aspect of the invention, a user connectivity system for a vehicle is presented. In one exemplary implementation, the user connectivity system comprises a communication system configured to communicate with cloud-based servers via a wireless communication network, the cloud-based servers hosting a set of cloud-based application programming interfaces (APIs) and a control system configured to establish a user connectivity platform that enables user customization of a plurality of sequences each for automated execution of set of respective actions by the vehicle, receive, by the user connectivity platform and from a user, user input defining a user-customized sequence defining a set of trigger conditions and a set of actions, monitor, by the user connectivity platform and using the communication system, for whether the set of trigger conditions for the user-customized sequence has been satisfied, and in response to the set of trigger conditions for the user-customized sequence being satisfied, automatically execute the set of actions for the user-customized sequence.

In some implementations, the user connectivity platform is configured to automatically execute the set of actions for the user-customized sequence without any input from the user. In some implementations, the user-customized sequence is a time-based sequence that has at least one time-based trigger. In some implementations, the user-customized sequence is a location-based sequence that has at least one vehicle location-based trigger. In some implementations, the set of cloud-based APIs include a weather API. In some implementations, the user customization of the plurality of sequences is performable without involvement of original equipment manufacturer (OEM) of the vehicle. In some implementations, the user customization of the plurality of sequences is performable without a software update of the vehicle. In some implementations, the user input is provided by a remote, authorized computing device associated with the user.

According to another example aspect of the invention, a user connectivity method for a vehicle is presented. In one exemplary implementation, the user connectivity method comprises establishing, by a control system of the vehicle and via a communication system of the vehicle, communication with cloud-based servers via a wireless communication network, the cloud-based servers hosting a set of cloud-based APIs, establishing, by the control system, a user connectivity platform that enables user customization of a plurality of sequences each for automated execution of set of respective actions by the vehicle, receiving, by the user connectivity platform and from a user, user input defining a user-customized sequence defining a set of trigger conditions and a set of actions, monitoring, by the user connectivity platform and using the communication system, for whether the set of trigger conditions for the user-customized sequence has been satisfied, and in response to the set of trigger conditions for the user-customized sequence being satisfied, automatically executing, by the user connectivity platform, the set of actions for the user-customized sequence.

In some implementations, the user connectivity platform is configured to automatically execute the set of actions for the user-customized sequence without any input from the user. In some implementations, the user-customized sequence is a time-based sequence that has at least one time-based trigger. In some implementations, the user-customized sequence is a location-based sequence that has at least one vehicle location-based trigger. In some implementations, the set of cloud-based APIs include a weather API. In some implementations, the user customization of the plurality of sequences is performable without involvement of an OEM of the vehicle. In some implementations, the user customization of the plurality of sequences is performable without a software update of the vehicle. In some implementations, the user input is provided by a remote, authorized computing device associated with the user.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example user connectivity system according to the principles of the present application;

FIG. 2 is a functional block diagram of an example system architecture for the user connectivity system according to the principles of the present application; and

FIG. 3 is a flow diagram of an example user connectivity method for a vehicle according to the principles of the present application.

### DESCRIPTION

As previously discussed, conventional vehicles include features and applications that are very limited and are hardcoded by the original equipment manufacturers (OEMs), such as into a head unit infotainment system. This results in a “one-size-fits-all” functionality without any tailoring to each user. For example, conventional vehicles may only be capable of displaying weather information without taking any automated actions based on that weather information. The process of developing and launching new features also takes a long time (e.g., ˜18 months) and then requires a vehicle update (e.g., a firmware over-the-air, or FOTA update). As more connected services arise (weather, sports, location-based services, etc.), manual user monitoring of conditions (e.g., via another application, such as one executing on their mobile device) and the user then taking corresponding actions becomes increasingly difficult.

Accordingly, an improved platform that enables extensive personalization and customization of automated vehicle monitoring and action execution is presented herein. The vehicle operations performable by the systems and methods of the present application can include, for example, remote/scheduled operations and location-based operations. These operations can use/access any cloud-based application program interfaces (APIs), such as weather and location-based services. Once these operations are created (e.g., by specifying rules/triggers), the vehicle creates and handles a cascading queue of functions for execution (web-based requests, texting, email, remote vehicle operations, vehicle notifications, etc.).

In addition to (i) new features being enabled in minutes as opposed to months/years and (ii) no vehicle update being required, these techniques allow for complete user customization to leverage their own vehicle's data to automate helpful actions tailored to their needs. This user-driven personalization powered by vehicle data fosters a stronger engagement between the user and their vehicle. The automation and connectivity help weave the vehicle into the user's life and routines. For example only, a user could configure an automated text message to be sent to their spouse when they leave work based on the vehicle's location. Alternatively, for example only, their a vehicle's head unit could be flashed or notified if it detects rain when the windows are open and the user could be alerted and/or the windows could be automatically closed, provided other safety checks are satisfied.

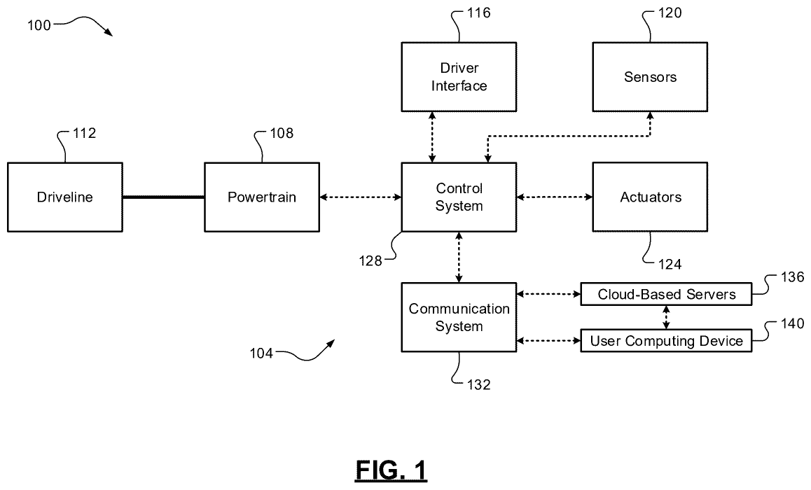

Referring now to FIG. 1, a functional block diagram of a vehicle 100 having an example user connectivity system 104 according to the principles of the present application is illustrated. The vehicle 100 generally comprises a powertrain 108 (e.g., an internal combustion engine, one or more electric motors, or some combination thereof) configured to generate and transfer drive torque to a driveline 112 for vehicle propulsion. The vehicle 100 also includes a user interface 116, which includes a plurality of devices each capable of receiving user input and/or providing output to a user of the vehicle 100. Non-limiting examples of the components of the user interface 116 include an instrument panel cluster (IPC), a touch display (e.g., as part of an infotainment unit), and user-actuatable input devices (buttons, knobs, etc.).

The vehicle 100 also includes a set of sensors 120 configured to measure operating parameters of the vehicle 100 and a set of actuators 124 configured to actuate various vehicle sub-systems. The vehicle 100 also includes a controller or control system 128 configured to control operation of the vehicle 100. This primarily includes controlling the powertrain 108 to generate a desired amount of drive torque to satisfy a driver torque request (e.g., provided by a driver via the user interface 116, such as an accelerator pedal). The control system 128 also performs at least a portion of the user connectivity techniques of the present application. The user connectivity system 104 thus includes the control system 128, a communication system 132, and a set of cloud-based servers 136. The communication system 132 is configured for communication with the cloud-based servers 136 via a wireless communication network (e.g., a cellular data network) and is also configured to vehicle-to-vehicle (V2V) or vehicle-to-anything (V2X) communication. A user (e.g., an owner or authorized operator of the vehicle 100) may also be able to provide user inputs via an authorized computing device 140 (e.g., a mobile phone) as part of the techniques of the present application.

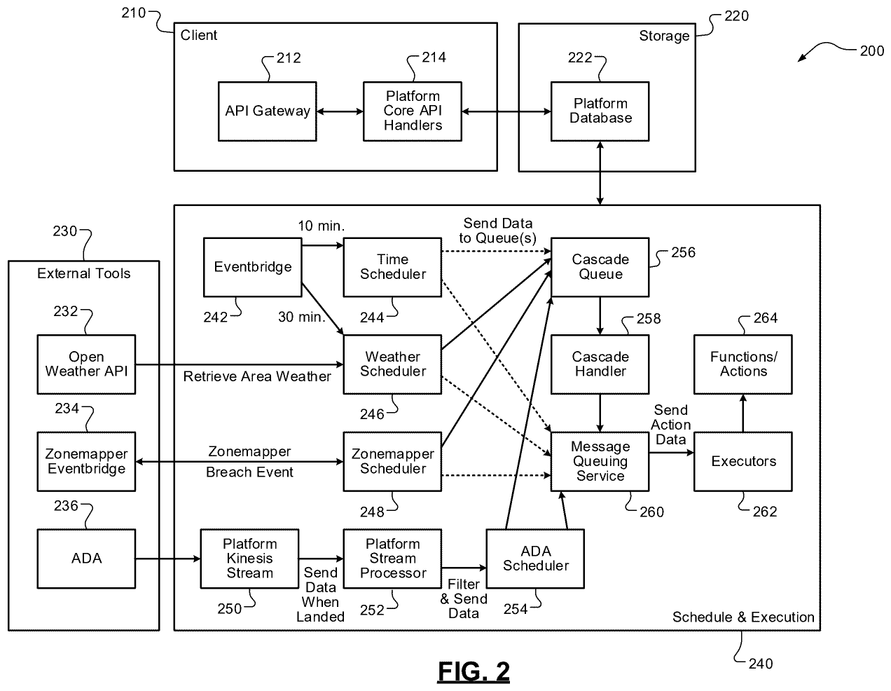

Referring now to FIG. 2, a functional block diagram of an example system architecture 200 for the user connectivity system 104 according to the principles of the present application is illustrated. To interface with the platform, its application programming interface (API) must be used. As shown, the client 210 (e.g., the vehicle 100) utilizes an API gateway 212 to communicate with platform core API handlers 214, which in turn communicate with the platform database 222 in storage system 220. The API is responsible for handling user requests to create, update, and delete sequences (i.e., user-customized features). In one exemplary implementation, the platform database 222 could be remotely stored (behind the scenes) in (e.g., an Amazon® Web Services, or AWS®, hosted PostgreSQL database).

The system architecture 200 further includes a set of external (e.g., cloud-based) tools 230 and a scheduling and execution sub-system 240. The scheduling and execution sub-system 240 is configured to interact with the database 222 as shown. In the example provided, there are four different schedulers: a time scheduler 244, a weather scheduler 246, a zonemapper scheduler 248, and an ADA scheduler 254. It will be appreciated that there could be other numbers and other types of schedulers. Each scheduler is for a different type of trigger. As such, they all behave in a slightly different manner. Triggers can also be either vehicle-based or cloud-based, and one or multiple triggers can be used to evaluate if a particular action should be taken. Triggers can include, for example only, time, location, weather, and vehicle sensor inputs (temperatures, pressures, states/statuses, etc.).

The time scheduler 244 runs every set period (e.g., 10 minutes) using a rule from an eventbridge 242 to run it. The time scheduler 244 then retrieves all sequences with a time trigger as the first trigger in a sequence and checks to see if it is ready to be scheduled to run. This works be sending a delayed message to the executors 262 through one of the queues 256, 260. The weather scheduler 246 runs every set period (e.g., 30 minutes) using a rule from the eventbridge 242 to run it, much like the time scheduler 244 as discussed above. The weather scheduler 246 thus also searches for weather events. However, the weather scheduler 246 also makes an API request to an open weather API 232 for the coordinates (e.g., latitude and longitude) of the vehicles (e.g., by vehicle identification number, or VIN) needed for the following weather report in any VIN's given area. The weather scheduler 246 will then send a message to one of the executors 262 through one of the queues 256, 260.

The zonemapper scheduler 248 interacts with a connected service of the same name—i.e., the zonemapper eventbridge 234. The zonemapper scheduler 248 works utilizing the events that the zonemapper eventbridge 234 creates to know when to send a message to the executors 260. For example, this event could be when the vehicle 100 leaves or is no longer within a zone or a “geo-fence” area. The ADA scheduler 254 utilizes the platform kinesis stream 250 generated by creating a policy through a ADA 236 (e.g., a web application). The platform kinesis stream 250 continuously sends a stream of data (when landed) to a platform stream processor 252, which filters and processes the data for the ADA scheduler 254. It will be appreciated that these schedulers and the corresponding connected services are merely examples and that the techniques of the present application are applicable to any suitable schedulers and connected/cloud services. Any vehicle/VIN that has the platform attached or associated therewith has the potential to use this feature. The ADA scheduler 254 works by checking the sensor values retrieved from the vehicle 100 against the values provided through the sequence.

One a message is sent through one of the queues 256, 260 from the schedulers, it will arrive in one of two places. If a scheduler's precondition is met, it will check if there are remaining triggers that need to be checked. In the case that there are, a message will be sent to the cascade handler 258, which handles checking further trigger conditions through API requests. Lastly, if there are no remaining triggers in any of the schedulers, or if the cascade handler 258 has finished, a message will be sent through to the executors 262. The executors 262 are responsible for performing the features or actions described in a sequence. Features or actions can include, for example only, web-based operations (e.g., hypertext transfer protocol, or HTTP messages), vehicle actuator/system operations, and messaging operations (text/SMS messaging, email, etc.).

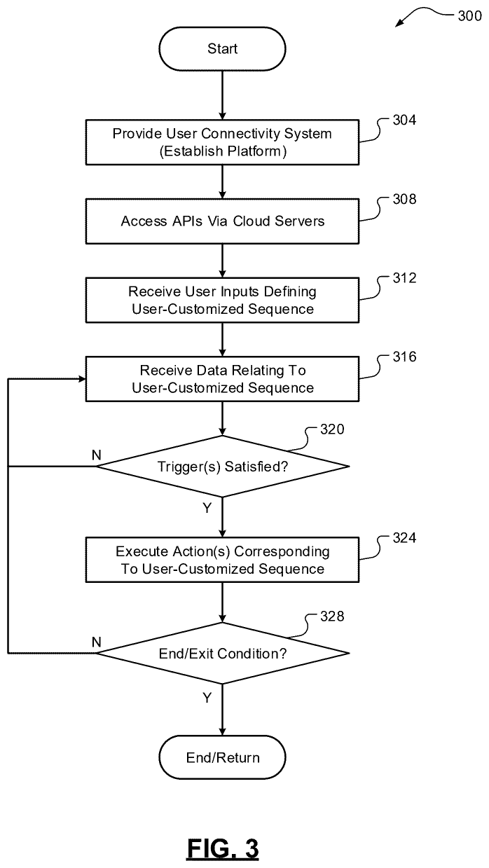

Referring now to FIG. 3, a flow diagram of an example user connectivity method 300 for a vehicle according to the principles of the present application is illustrated. While the vehicle 100 and the system architecture 200 may be referenced for descriptive/illustrative purposes, it will be appreciated that the method 300 could be applicable to any suitably configured vehicle. The method 300 begins at 304 where the user connectivity system 104 is provided or, in other words, the platform is established and initialized. At 308, access to the external tools 230 (e.g., cloud-based APIs) is established via the communication system 132. At 312, user inputs defining customized features or sequences (e.g., trigger(s) and action(s)) are provided. This customization could be done in the vehicle 100 via the user interface 116, via an authorized computing device (e.g., a mobile phone) associated with the user, or some combination thereof.

At 316, the user connectivity system 104 monitors for or receives data relating to the user-customized features or sequences. At 320, the user connectivity system 104 determines whether a set of one or more triggers for a particular sequence have been satisfied. When false, the method 300 returns to 316 where monitoring continues. When true, the method 300 proceeds to 324 where the user connectivity system 104 executes one or more actions associated with the feature or sequence that had the satisfied trigger(s). At 328, it is determined whether an end or exit condition is presented. For example, the vehicle 100 could be powered down/off or be undergoing service. When false, the method 300 returns to 316 (or an earlier step, such as 308 or 312 for further user customization). When true, the method 300 ends, but it will be appreciated that the method 300 could be initiated again upon satisfying other conditions (e.g., a vehicle power-up or restart).

It will be appreciated that the terms “controller,” “control system,” “server,” and “computing device” as used herein refer to any suitable computing device or set of multiple computing devices that is/are configured to perform at least a portion of the techniques of the present application. Non-limiting examples include an application-specific integrated circuit (ASIC), one or more processors (central processing units (CPUs), graphical processing units (GPUs), etc.) and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A user connectivity system for a vehicle, the user connectivity system comprising:
a communication system configured to communicate with cloud-based servers via a wireless communication network, the cloud-based servers hosting a set of cloud-based application programming interfaces (APIs); and
a control system configured to:
establish a user connectivity platform that enables user customization of a plurality of sequences each for automated execution of set of respective actions by the vehicle;
receive, by the user connectivity platform and from a user, user input defining a user-customized sequence defining a set of trigger conditions and a set of actions;
monitor, by the user connectivity platform and using the communication system, for whether the set of trigger conditions for the user-customized sequence has been satisfied; and
in response to the set of trigger conditions for the user-customized sequence being satisfied, automatically execute the set of actions for the user-customized sequence.

2. The user connectivity system of claim 1, wherein the user connectivity platform is configured to automatically execute the set of actions for the user-customized sequence without any input from the user.

3. The user connectivity system of claim 1, wherein the user-customized sequence is a time-based sequence that has at least one time-based trigger.

4. The user connectivity system of claim 1, wherein the user-customized sequence is a location-based sequence that has at least one vehicle location-based trigger.

5. The user connectivity system of claim 1, wherein the set of cloud-based APIs include a weather API.

6. The user connectivity system of claim 1, wherein the user customization of the plurality of sequences is performable without involvement of original equipment manufacturer (OEM) of the vehicle.

7. The user connectivity system of claim 1, wherein the user customization of the plurality of sequences is performable without a software update of the vehicle.

8. The user connectivity system of claim 1, wherein the user input is provided by a remote, authorized computing device associated with the user.

9. A user connectivity method for a vehicle, the user connectivity method comprising:
establishing, by a control system of the vehicle and via a communication system of the vehicle, communication with cloud-based servers via a wireless communication network, the cloud-based servers hosting a set of cloud-based application programming interfaces (APIs);
establishing, by the control system, a user connectivity platform that enables user customization of a plurality of sequences each for automated execution of set of respective actions by the vehicle;
receiving, by the user connectivity platform and from a user, user input defining a user-customized sequence defining a set of trigger conditions and a set of actions;
monitoring, by the user connectivity platform and using the communication system, for whether the set of trigger conditions for the user-customized sequence has been satisfied; and
in response to the set of trigger conditions for the user-customized sequence being satisfied, automatically executing, by the user connectivity platform, the set of actions for the user-customized sequence.

10. The user connectivity method of claim 9, wherein the user connectivity platform is configured to automatically execute the set of actions for the user-customized sequence without any input from the user.

11. The user connectivity method of claim 9, wherein the user-customized sequence is a time-based sequence that has at least one time-based trigger.

12. The user connectivity method of claim 9, wherein the user-customized sequence is a location-based sequence that has at least one vehicle location-based trigger.

13. The user connectivity method of claim 9, wherein the set of cloud-based APIs include a weather API.

14. The user connectivity method of claim 9, wherein the user customization of the plurality of sequences is performable without involvement of an original equipment manufacturer (OEM) of the vehicle.

15. The user connectivity method of claim 14, wherein the user customization of the plurality of sequences is performable without a software update of the vehicle.

16. The user connectivity method of claim 9, wherein the user input is provided by a remote, authorized computing device associated with the user.
